(19) United States
(12) Patent Application Publication
(10) Pub. No.: US 2005/0095080 A1
(43) Pub. Date: May 5, 2005

(54) Structure for coupling bolt and clamp for automobile

(76) Inventor: Hyung Tae Kim, Wanju-gun (KR)

Correspondence Address: MORGAN, LEWIS & BOCKIUS LLP (SF), 2 PALO ALTO SQUARE, PALO ALTO, CA, 94306, US

(21) Appl. No.: 10/899,686

(22) Filed: Jul. 27, 2004

(30) Foreign Application Priority Data
Oct. 31, 2003 (KR) 2003-76620

(51) Int. Cl. F16B 21/00

(52) U.S. Cl. 411/349

(57) ABSTRACT

A bolt includes a head part and a body part. An engaging groove is configured on the body part. A compression bracket type clamp is coupled to the concave engaging groove of the body part for thereby coupling the bolt with the clamp. The bolt is easily engaged with the clamp by pushing the bolt through a hole in the clamp until fixtures of the clamp engage the engaging groove. To disengage the bolt from the clamp, the bolt is rotated roughly 90 degrees until the fixtures are spread to the outer circumference of the bolt such that the bolt can be removed from the clamp.

### CROSS REFERENCE TO RELATED APPLICATION

This application claims priority of Korean Application No. 10-2003-0076620, filed Oct. 31, 2003, the disclosure of which is incorporated herein by reference.

### FIELD OF THE INVENTION

Generally, the present invention relates to a structure for coupling a bolt and a clamp. More particularly, the structure is formed having a bolt with a head part, a body part, and a compression bracket type clamp that is coupled to a concave groove of the body part for thereby coupling the bolt.

### BACKGROUND OF THE INVENTION

Typically, a bolt and a nut are adapted to engage at least two elements making one integral element. Bolts and nuts are used in various fields such as automobile part assembling line, electronic part assembling line, furniture assembling line, etc. According to Japanese patent laid open No. 2003-54454, a T-shaped bolt is provided for coupling a side seal and a side under spoiler wherein a bolt and a nut are generally used for assembling the parts of an automobile. According to Japanese patent laid-open No. 04-366010, there is provided a thermosetting resin in an inner surface in which a bolt and a plate contact for thereby enhancing a sealing property between the bolt and the plate. Additionally, according to Japanese patent laid open No. 2000-52900, a bolt and a nut are used for securely fixing a heavy bumper and are used for a fixing club.

However, in the typical structure for coupling a bolt and a nut, the bolt and nut must be tightened by rotating the bolt a few times along the threads of the nut. As a result, the amount of work for coupling the bolt and nut is substantial and the work process of an assembly line is complicated. Furthermore, often when the bolt and the nut maintain an engaged state over a period of time, the components are know to loosen. Therefore, it would be beneficial to provide a simpler structure that reduces the amount of work required to secure multiple components together and provide a system that resists loosening.

### SUMMARY OF THE INVENTION

Embodiments of the present invention provide a coupling structure formed of a bolt with a head part and a body part. A compression bracket type clamp is coupled to a concave groove of the body part for thereby fixing the bolt. The bolt and clamp are easily engaged and disengaged and the number of work processes is significantly decreased. Even when the structure is used over a long period of time, abrasion of the structure does not occur.

To achieve the above objects, there is provided a structure for coupling a bolt and a clamp for an automobile. The structure includes a bolt that includes a body part inserted into coupled elements. A head part is integrally formed with an end of the body part wherein a semicircular engaging groove on both sides is formed in an outer diameter portion of the body part. A conical protrusion is formed at a front end of the bolt. A compression bracket shaped clamp includes a bent part in which a plate member, with an engaging hole at a center portion, is inwardly bent at two points with a certain distance. A pair of fixtures are formed at a front end of the compression bracket and are outwardly bent wherein the fixtures are supposed to be tightened in an opposite state. According to an embodiment, the length of the body part is extendable. The engaging grooves on opposite sides of the body of the bolt are substantially a v-shape. The engaging grooves are formed by a steeply tapered portion on an upper part of the body distal from the head while on the lower part proximal to the head is a slightly tapered portion.

### BRIEF DESCRIPTION OF THE DRAWINGS

The aforementioned aspects and other features of the present invention will be explained in the following detailed description, taken in conjunction with the accompanying drawings, in which:

FIG. 1 is a disassembled perspective view illustrating a structure for coupling a bolt and a clamp according to an embodiment of the present invention; and

FIG. 2 is a view of a method of operation of a structure for coupling a bolt and a clamp according to an embodiment of the present invention.

### DETAILED DESCRIPTION OF PREFERRED EMBODIMENTS

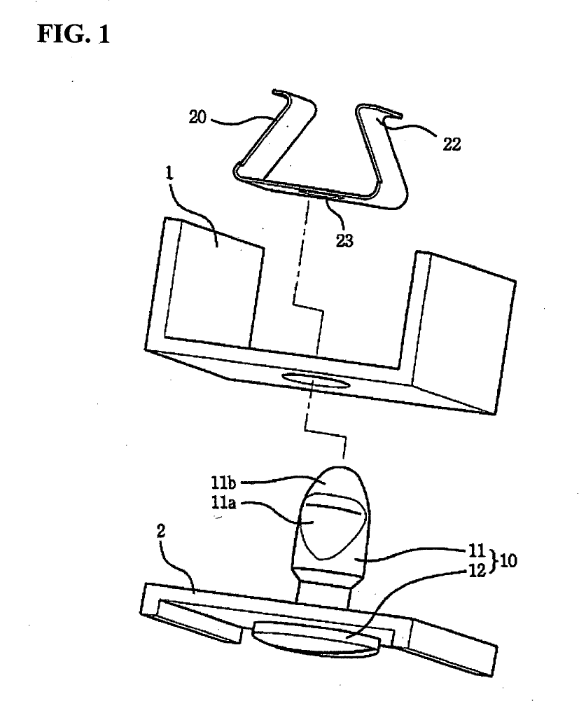

According to FIG. 1, bolt 10 includes a body part 11 and a head part 12 integrally formed with one end of the body part 11. In use, the body part 11 of bolt 10 is inserted through an opening in coupled elements 1 and 2. A semicircular engaging groove 11a is configured on both sides of body part 11 distally away from head part 12. The semicircular engaging groove 11 a is formed in an outer diameter portion of the body part 11 of the bolt 10. One portion of the engaging groove 11a, distal from the head, is steeply tapered while the lower part of the engaging groove 11, proximal to the head, is slightly tapered. Therefore, a fixture 22 is retained in the engaging groove 11a and kept from escaping when the fixture 22 of the clamp 20 is engaged to the engaging groove 11a. In addition, a front end of the body part 11 includes a conical protrusion 11b, thus providing for easy installation of body part 11 into and through a receiving opening in elements 1 and 2 and the clamp 20.

According to a preferred embodiment, the length of the body part 11 is extendable, and the distance of the contacting surfaces between the head part 12 of the bolt 10 and the clamp 20 is configured to be the same or similar to the distance between the coupled elements 1 and 2. Preferably, the distance of the contacting surface of the head part 12 and the clamp 20 is configured for a particular application and configured to be close to the same thickness of the elements to be coupled. Therefore, the bolt structure will hold the elements tightly and firmly.

The clamp 20 is formed in a shape of a compression bracket. The clamp 20 includes a bent part 21 in which a plate member is inwardly bent at two points, thereby forming a proper distance between the two end portions of the clamp 20 to apply a pressure to the engaging groove 11a. A fixture 22 of which a front end is externally bent is also formed such that the clamp 20 is retained in the engaging groove 11a following installation. An engaging hole 23 is formed in the center of the clamp 20 such that the bolt 10 can be inserted into and through the engaging hole 23. The opposite fixtures 22 are designed to elastically tighten and to be neighbored from each other.

When the fixtures 22 are inserted into the engaging groove 11a of the body part 11a, they are elastically tightened and thereby prevent an escape of the clamp 20 from the bolt 10.

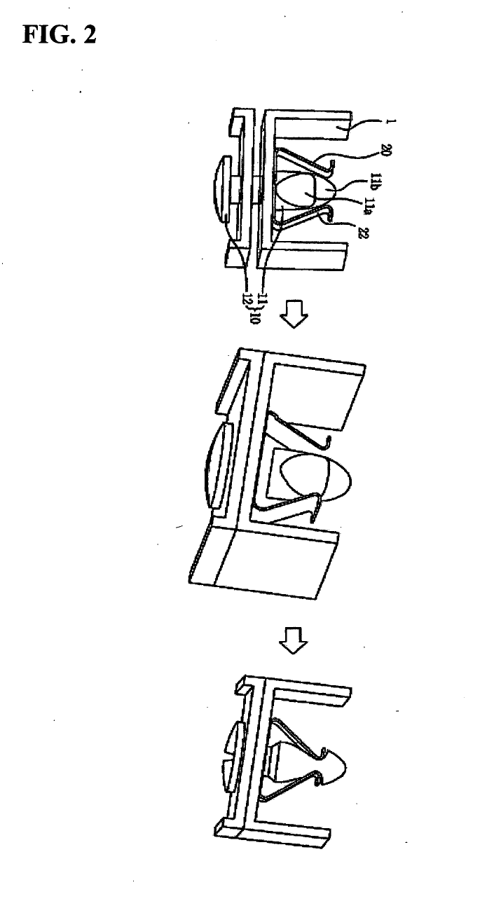

Operation of the bolt 10 and clamp 20 will be described with reference to FIG. 2. The body part 11 of the bolt 10 is inserted into a pair of elements 1 and 2 that are to be coupled. Next, the clamp 20 is inserted onto the bolt 10 through the engaging hole 23. At this time, the protrusion 11b of the bolt 10 is proposed to push each fixture 22. Fixture 22 widens due to its elasticity until fixtures 22 reach the engaging groove 11a of the bolt 10. Upon reaching the engaging groove 11a, the fixtures 22 relax into and become engaged within the engaging groove 11a. Thereby sturdily tightening the clamp 20 onto the bolt 10.

When disengaging the bolt 10 from the clamp 20, the bolt 10 is rotated in one direction roughly 90 degrees. The fixtures 22 are elastically widened in both directions along the outer diameter portion of the body part 11. The bolt 10 and the clamp 20 now become disengaged and the bolt 10 is capable of being withdrawn from the clamp 20. Next, the body part 11 of the bolt 10 can be disengaged from the engaging hole 23 of the clamp 20.

Therefore, in the structure for coupling the bolt and clamp for an automobile according to an embodiment of the present invention, the amount of rotation operation of the bolt 10 is significantly decreased as compared with the conventional art, thereby easily engaging and disengaging the bolt and clamp structure. Furthermore, work time and assembly time is reduced and the structure resists loosening and a typical abrasion of a bolt and nut combination caused by mechanical friction due to vibration of the device at the point where the bolt and nut are installed is significantly decreased, thus quality of an automobile is improve.

1. A structure for coupling a bolt and a clamp for an automobile, comprising:
a bolt having a body part inserted into coupled elements;
a head part integrally formed with an end of the body part wherein a semicircular engaging groove corresponding to both sides thereof is formed in an outer diameter portion of the body part, and a conical protrusion is formed at a front end of the same; and
a compression bracket shaped clamp includes a bent part 21 in which a plate member with an engaging hole at a center portion of is inwardly bent at two points with a certain distance and a pair of fixtures that are formed at a front end are outwardly bent wherein the fixtures are supposed to be tightened in an opposite state.

2. The structure of claim 1, wherein a length of said body part is extendable.

3. The structure of claim 1, wherein said engaging groove has a steeply tapered portion distal from the head and a slightly tapered portion proximal to the head.

4. A structure for coupling elements, comprising:
a bolt having a head and a body part;
a generally conical tip formed at a distal end of said body part, distal from said head;
an engaging groove positioned on opposite sides of said body part, wherein said engaging groove includes at least two tapered sections, a first slight tapered section tapering toward the tip of the bolt from the head of the bolt and a second steep tapered section tapering from the tip of the bolt toward the head of the bolt, whereby the tapered sections form a reduced cross sectional thickness of said body part; and
a compression clamp defining a receiving hole configured to receive said body part, wherein said compression clamp forms extending fixtures configured to be elastically received within said engaging groove, said extending fixtures including enlarged ends configured to abut the steep tapered section of said body part and thereby restrain said compression clamp coupled with said bolt once engaged.
